(19) United States
(12) Patent Application Publication
(10) Pub. No.: US 2023/0203674 A1
(43) Pub. Date: Jun. 29, 2023

(54) METHOD FOR PRODUCING ALUMINUM OXIDE POWDER BY ELECTROCHEMICAL DISSOLVING ALUMINUM SALT

(71) Applicant: NATIONAL CHUNG SHAN INSTITUTE OF SCIENCE AND TECHNOLOGY, Taoyuan City (TW)

(72) Inventors: JIAN-LONG RUAN, Taoyuan City (TW); YANG-KUAO KUO, Taoyuan City (TW)

(21) Appl. No.: 17/560,303

(22) Filed: Dec. 23, 2021

(51) Int. Cl. C25B 1/01; B22F 9/14; C25B 9/65; C25B 1/50

(52) U.S. Cl. CPC C25B 1/01; B22F 9/14; C25B 9/65; C25B 1/50; B22F 2304/10; B22F 2302/253

(57) ABSTRACT

Provides a method for producing aluminum oxide powder by electrochemical dissolving aluminum salt, comprise: (A) providing an electrochemical device with an aluminum material as an anode and an acidic solution as an electrolyte; (B) accelerating the dissolution of the aluminum material by current pulse method to form an acidic aluminum salt solution; (C) neutralizing the acidic aluminum salt solution with a basic solution to form an aluminum hydroxide sol; (D) adding an additive in the aluminum hydroxide sol, filtering the aluminum hydroxide sol and drying to obtain aluminum hydroxide powder; (E) roasting the aluminum hydroxide powder to form micron scale γ-aluminum oxide powder. Combines the acidic aluminum salt method and the electrochemical dissolution method to improve the dissolving rate of the aluminum material and increase the output efficiency of the acidic aluminum salt, and obtaining micron scale γ-aluminum oxide powder.

### BACKGROUND OF THE INVENTION

### 1. Field of the Invention

The present disclosure relates to a method for producing aluminum oxide powder, and in particular to a method for producing an end product of γ-aluminum oxide powder and producing an intermediate product of nanoscale aluminum hydroxide powder by electrochemical dissolution method.

### 2. Description of the Related Art

Aluminum nitride (AlN) is a new type of electronic ceramic material, because of its excellent thermal conductivity and electrical insulation and other features, has become one of the most popular cutting-edge materials, which has special physical properties comprising: high thermal conductivity, high resistivity, low dielectric constant, low thermal expansion coefficient, good heat resistance, good mechanical strength, high chemical stability, non-toxic feature and other features, can be applied to electronic ceramic substrates, electronic elements packaging materials, corrosion-resistant elements, high thermal additives and other applications. At present, the commercial mass production of aluminum nitride powder is mainly based on two preparation methods: self-propagation high-temperature synthesis (combustion synthesis) method and carbothermic reduction process, but the purity of aluminum nitride powder produced by combustion synthesis method is low, while the purity of aluminum nitride powder obtained by carbothermic reduction process is high. However, the starting material required for the carbothermic reduction process is γ phase aluminum oxide, because its crystal structure is relatively unstable, it is not easy to fabricate.

It has been reported that aluminum oxide has many phases in past studies, such as γ-aluminum oxide, which is often used as a catalyst, and others, such as, α-aluminum oxide, ρ-aluminum oxide, χ-aluminum oxide, η-aluminum oxide, δ-aluminum oxide, θ-aluminum oxide, etc., in which α-aluminum oxide is the most stable phase in aluminum oxide thermodynamics and is widely used in ceramic substrates and thermal grease in industry, which is of great economic value. However, the objective of the disclosure is to apply to the γ-aluminum oxide of nitride, α-aluminum oxide is too stable to be used for nitride reaction.

Aluminum oxide has a variety of crystal structures, the most common two structures are α-Al₂O₃ and γ-Al₂O₃, of which the α-Al₂O₃ is a hexagonal close packing structure, six oxygen atoms forms octahedron, the entire crystal has two thirds that is occupied by aluminum atoms, such a close packing has a great lattice energy, so α-Al₂O₃ has a high melting point, good mechanical strength, corrosion resistance, and good insulation and heat conductivity, can be used in refractory materials, electronic elements packaging materials and sapphire raw materials, but the thermal dissipation effect is not as good as aluminum nitride. The γ-Al₂O₃ crystal is a face-centered cubic structure, Al atoms are irregularly arranged in holes of the octahedron and tetrahedron surrounded by oxygen atoms, the hardness of such a structure is not high, the structure has a large surface area, is a small particle, high adsorption capacity and catalytic activity and other advantages, and γ-Al₂O₃ is more active than α-Al₂O₃, more soluble in acidic or basic solution, also known as active aluminum oxide, can be applied to adsorbents and catalysts. Because of the close structure of the α-Al₂O₃, α-Al₂O₃ has properties of good thermal dissipation and insulation, although α-Al₂O₃ is an important material in industry, but the lattice structure is stable that is not easy to convert to aluminum nitride. Therefore, the γ-Al₂O₃ crystal powder that has a relatively unstable lattice structure is the best starting material for carbothermic reduction synthesis of aluminum nitride.

However, it is found from the literature that the conversion rate of aluminum nitride by carbothermic reduction process can be as high as 97% under high temperature conditions, but the yield is limited by (a) the purity of aluminum oxide, (b) the crystalline phase of aluminum oxide, and (c) aluminum oxide morphology in the front-end process. Therefore, the key point to achieve the ultimate goal of aluminum nitride powder synthesis lies in the technical development of aluminum oxide in the front-end process. The main technology for producing aluminum oxide from aluminum raw materials is the following three preparation methods:

1. Basic aluminum salt method: dissolving pure aluminum in alkali to form aluminum salts, for example, Al(OH)₄⁻ called tetrahydroxoaluminate or metaaluminate, and then acid is added, so that aluminum salt is converted into a neutral aluminum hydroxide powder (Al(OH)₃), and then sintering is carried out to produce aluminum oxide, the reaction equations are as follows.

2Al₍ₛ₎+2KOH_{(aq)}+6H2O→2K⁺_{(aq)}+2Al(OH)l₄⁻_{(aq)}+3H_{2(g)}

Al(OH)₄⁻_{(aq)}+H⁺_{(aq)}→Al(OH)₃₍ₛ₎+H₂O

2Al(OH)₃→Al₂O₃+3H₂O

2. Acidic aluminum salt method: dissolving pure aluminum in a dilute acid, for example, hydrochloric acid or sulfuric acid to form an aluminum salt, and then the formed aluminum salt is added into ammonia water (NH₄OH), so that the aluminum salt is reacted into a neutral aluminum hydroxide powder (Al(OH)₃), and finally sintering is carried out to produce aluminum oxide, the reaction equations are as follows.

2Al+6HCl→2AlCl₃+3H₂(g)

AlCl₃+3NH₄OH→Al(OH)₃↓+3NH₄Cl

or

Al₂(SO₄)₃+6NH₄OH→2Al(OH)₃↓+3(NH₄)₂SO₄

2Al(OH)₃→Al₂O₃+3H₂O

3. Organo-aluminum alcoholate method: combining pure aluminum and isopropanol or isooctyl alcohol, a catalyst of aluminum chloride (AlCl₃) or mercurous chloride (Hg₂Cl₂) is added to produce aluminum alcoholate, and then hydrolysis is carried out to obtain aluminum hydroxide Al(OH)₃, and finally sintering is carried out to produce aluminum oxide, the method produces aluminum oxide powder that has a high-purity and small particle size. The reaction equations of the preparation of aluminum oxide with isopropanol are as follows:

Al+3i-C₃H₇OH→(i-C₃H₇O)₃Al+3/2H₂(g)

2(i-C₃H₇O)₃Al+3H₂O→2Al(OH)₃(s)

2Al(OH)₃→Al₂O₃+3H₂O

The reaction equations of the preparation of aluminum oxide with isooctyl alcohol are as follows:

Al+3i-C₈H₁₇OH→Al(OC₈H₁₇)₃→Al(OH)₃+3i-C₈H₁₇OH

2Al(OH)₃→Al₂O₃+3H₂O

CN104556177A of invention patent disclosed a sheet nano γ-Al₂O₃ and a preparation method thereof, the sheet nano γ-Al₂O₃ of the invention is prepared by adopting aluminum salt method, it is prepared by mixing an inorganic aluminum salt solution of certain concentration with a basic solution, and performing sectional hydrothermal crystallization (in 140-180° C. of hydro-thermal reaction for 3-5 hours, afterwards, 200-250° C. of hydro-thermal reaction for 3-12 hours is continued), wherein the basic substance in the basic solution is one or more of sodium hydroxide, potassium hydroxide or lithium hydroxide. After the hydro-thermal product is carried out high-temperature roasting at 450-750° C. for 2-8 hours, the sheet nano γ-Al₂O₃ powder is obtained. CN101269829A of invention patent disclosed a γ-Al₂O₃ material with a large specific surface area and a preparation method thereof, the invention adopts aluminum alcoholate method, the γ-Al₂O₃ material is prepared by dissolving aluminum in isopropanol, stirring at 45-80° C. for 10-20 hours until aluminum to be dissolved, adding milk and water, continuously stirring for 4 hours, charging into the reaction kettle, and crystallizing at 80° C. for 3 days to obtain powder.

The obtained powder is ignited at 600° C. for 4 hours to obtain γ-Al₂O₃ powder. CN1316382A of invention patent disclosed a process for preparing aluminum oxide by reacting aluminum with isopropanol in the presence of catalyst to obtain aluminum alcoholate, hydrolyzing to obtain aluminum hydroxide and roasting. In the process of synthesizing aluminum alcoholate, the synthesis temperature of aluminum alcoholate is controlled at 145-155° C., holding the temperature for 120 minutes by means of the speed of adding alcohol and passing cooling water into the heat exchanger in the reaction kettle, and then the reduced pressure distillation is carried out under the condition of 666 Pa and 138° C. Next, hydrolysis is carried out with isopropanol and pure water as medium, hydrolysis conditions are degree of vacuum 200-400Pa, 50-70° C., 30 minutes, followed by holding temperature at 90-98° C. for 600 minutes to carry out drying, finally, γ-Al₂O₃ powder can be obtained by roasting at 750° C. for more than 3 hours. U.S. Pat. No. 2,749,216A of invention patent disclosed a method for producing γ-Al₂O₃powder, the invention adopts aluminum alcoholate method, the γ-Al₂O₃ powder is prepared by dissolving aluminum in 1-pentanol, and mercury chloride is added as a catalyst to complete the synthesis reaction of aluminum alcoholate at 25-150° C., then hydrolysis is carried out to form Boehmite (γ-AlO(OH)), and finally roasting between 315 and 870° C. to produce γ-Al₂O₃ powder.

At present, the method for preparing aluminum oxide powder by aluminum raw materials mainly uses acidic and basic aluminum salt method or organo-aluminum alcoholate method. However, the dissolution rate of aluminum materials of acidic and basic aluminum salt method is slow, the process takes a long time, and as to the organo-aluminum alcoholate method, because aluminum is not easily soluble in alcohols, the reaction needs to add chloride or mercury-containing compounds as a catalyst, it is toxic and easy to cause environmental pollution, and once catalytic reaction is started, a large amount of reaction heat will be produced, careless control is easy to cause accidents.

Most of the patent disclosure contents of the public database are a phase aluminum oxide process, and the preparation of γ phase aluminum oxide is less described. For the preparation of high-purity aluminum nitride powder, there is a lack of the synthesis technology of key raw materials of metastable y phase aluminum oxide required for carbothermic reduction process. Under the flourishing industrial trend of high power and large thermal electronic elements, insulated high thermal conductive aluminum nitride is a potential material of thermal dissipation carrying substrates, so the key preparation technology of y phase aluminum oxide powder is in great need of the industry for synthesizing aluminum nitride, in order to develop high-purity aluminum nitride powder material.

In order to solve the above problems, in view of the above disadvantages of the prior art, the applicant of the disclosure uses aluminum raw materials as a starting raw material to improve the dissolution rate for preparing high-quality y phase aluminum oxide powder, based on the acidic aluminum salt process technology, going with electrochemical dissolution method and current pulse design, can be used as a starting y phase aluminum oxide raw material for carbothermic reduction process to prepare high-purity aluminum nitride powder. Accordingly, the technology of front-end process of aluminum nitride with the features of high efficiency, high purity and low cost was developed. The following is a brief description of the disclosure.

### BRIEF SUMMARY OF THE INVENTION

The present disclosure relates to a method for producing aluminum oxide powder, and in particular to a method for accelerating the dissolution rate of an aluminum material by electrochemical dissolution method and controlling the synthetic crystal phase of high-purity aluminum oxide in order to produce an end product of γ-aluminum oxide powder and to produce an intermediate product of nanoscale aluminum hydroxide powder. The γ-aluminum oxide powder produced can be used in carbothermic reduction process to obtain finished products of high-quality aluminum nitride powder.

According to the conception of the present disclosure, it provides a method for producing aluminum oxide powder by electrochemical dissolving aluminum salt, and steps comprise: (A) providing an electrochemical device with an aluminum material as an anode and an acidic solution as an electrolyte; (B) accelerating the dissolution of the aluminum material by current pulse method to form an acidic aluminum salt solution; (C) neutralizing the acidic aluminum salt solution with a basic solution to form an aluminum hydroxide sol, a particle size of the aluminum hydroxide sol is in the range of 1 to 10 μm; (D) adding an additive in the aluminum hydroxide sol to control the particle size of the aluminum hydroxide sol to the nanoscale, filtering the aluminum hydroxide sol and drying to form aluminum hydroxide powder, a particle size of the aluminum hydroxide powder is in the range of 30 to 300 nm; (E) roasting the aluminum hydroxide powder at a high temperature to form micron scale γ-aluminum oxide powder.

The aluminum material of the step (A) is an aluminum scrap or aluminum sheet with a purity of 3N grade or above; the electrochemical device is an electrochemical dual electrode system with one of platinum, gold and graphite as a cathode material.

The acidic electrolyte of the step (A) is selected from the group consisting of hydrochloric acid (HCl), sulfuric acid (H₂SO₄) and nitric acid (HNO₃), a concentration of the acidic electrolyte is between 0.5M and 3M.

The current pulse method of the step (B) sets constant current pulse by a power supply, the constant current pulse is 0.1 to 1.0 A/cm² and 10 seconds, 0 A/cm² and 15 seconds for a cycle, number of pulse current cycles is more than 20 times, the total electrolysis time is more than 500 seconds to accelerate the dissolution of the aluminum material, so as to form an acidic aluminum salt solution.

The basic solution of the step (C) is selected from the group consisting of sodium hydroxide (NaOH), ammonia water (NH₄OH) and potassium hydroxide (KOH), the basic solution is used to perform the acid-base neutralization of the acidic aluminum salt solution, and the pH is neutralized between 6 and 8 to form an aluminum hydroxide (Al(OH)₃) sol.

The additive of the step (D) is selected from the group consisting of sodium chloride (NaCl), ammonium chloride (NH₄Cl), 3-mercapto-1-propanesulfonic acid sodium salt (MPS) and 4-dodecylbenzenesulfonic acid (DBSA), a concentration of the additive is between 0.01M and 0.5M, and the acid-base value is controlled at pH value between 6 and 8.

The filtering and drying process of the step (D) is allowing the aluminum hydroxide sol to carry out suction filtration, and then is dried at a low temperature by oven or a heating plate with temperature set 80 to 100° C. to form nanoscale aluminum hydroxide powder.

The roasting temperature of the step (E) is between 600° C. and 900° C., and a temperature holding time is 1 to 5 hours, micron scale γ-aluminum oxide powder can be obtained after the high temperature roasting.

The disclosure combines acidic aluminum salt method and electrochemical dissolution method to improve the dissolving rate of aluminum material and increase the output efficiency of aluminum salt, using aluminum metal as the starting raw material, and going with the current pulse design. The aluminum salt is carried out the acid-base neutralization to produce an aluminum hydroxide sol, and an additive is added to the sol to control the particle size of the aluminum hydroxide sol, producing nanoscale aluminum hydroxide powder, reducing the roasting temperature of subsequent synthetic aluminum oxide powder, and finally obtaining high-quality micron scale γ-phase aluminum oxide powder after roasting at 600° C. to 900° C.

The purpose of the disclosure is to develop γ-phase aluminum oxide powder with characteristics of high purity and low cost, which can be used as a starting material for carbothermic reduction process and can be used for the synthesis of high-purity aluminum nitride powder. In addition to producing high-quality γ-phase aluminum oxide powder, the disclosure can also produce an intermediate product of aluminum hydroxide, which is also a ceramic material with high application value that enhances the added value of the technical conception.

The above summary description and the following detailed description and the accompanying drawings are the way, means and effect made for further describing the disclosure which can achieve a predetermined object. Other objects and advantages of the disclosure will become apparent from the following description and the drawings.

### BRIEF DESCRIPTION OF THE DRAWINGS

FIG. 1 is a flow chart of a method for producing aluminum oxide powder by electrochemical dissolving aluminum salt of the present disclosure.

FIG. 2 shows photos of the aluminum hydroxide sol after electrochemical dissolving the acidic aluminum salt and the neutralization with the basic solution according to an embodiment of the present disclosure.

FIG. 3 show photos of aluminum hydroxide powder obtained by the aluminum hydroxide sol after suction filtration and drying according to the embodiment of the present disclosure.

FIG. 4 is a spectrum of graph of scanning electron microscope of aluminum hydroxide powder according to the embodiment of the present disclosure.

FIG. 5 is a spectrum of graph of x-ray diffraction of aluminum oxide powder after high temperature roasting according to the embodiment of the present disclosure.

FIG. 6 is a spectrum of graph of scanning electron microscope of γ-aluminum hydroxide powder after the high temperature roasting synthesis of 700° C. according to the embodiment of the present disclosure.

### DETAILED DESCRIPTION OF THE INVENTION

The implementation of the disclosure is further described by the specific embodiments as below, and a person having ordinary skill in the art can easily understand other advantages and effects of the present disclosure by the content of the specification. However, the implementation of the disclosure is not limited by the following embodiments.

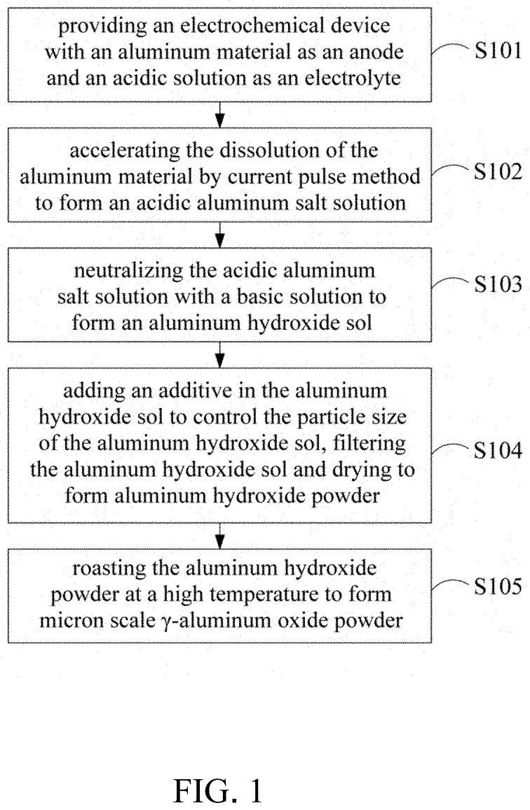

Referring to FIG. 1, FIG. 1 is a flow chart of a method for producing aluminum oxide powder by electrochemical dissolving aluminum salt of the present disclosure, steps comprising: providing an electrochemical device with an aluminum material as an anode and an acidic solution as an electrolyte, S101; accelerating the dissolution of the aluminum material by current pulse method to form an acidic aluminum salt solution, S102; neutralizing the acidic aluminum salt solution with a basic solution to form an aluminum hydroxide sol, S103; then, adding an additive in the aluminum hydroxide sol to control the particle size of the aluminum hydroxide sol to the nanoscale, filtering the aluminum hydroxide sol and drying to form aluminum hydroxide powder, S104; finally, roasting the aluminum hydroxide powder at a high temperature to form micron scale γ-aluminum oxide powder, S105.

As to the aluminum material described in step S101, an aluminum sheet with a purity of 3N grade or above is preferable in the embodiment, the size is 5 cm×2 cm, the thickness is about 2.5 to 3 mm, and a reaction area is defined by an acid and alkali-resistant tape as 6.6 cm²; the electrochemical device is an electrochemical dual electrode system with an aluminum sheet having a purity of 3N grade or above as an anode, a platinum sheet as a cathode, and an acidic solution as an electrolyte, and the electrochemical dissolution of the aluminum sheet is performed.

The aforementioned aluminum sheet needs to go through a pretreatment process to remove the oil stain and oxidation layer on the surface. First, the aluminum sheet is soaked into a detergent, and washed with ultrasonic cleaning for 10 minutes; after the aluminum sheet is cleaned with acetone, then the aluminum sheet is soaked with deionized water, and placed in an ultrasonic cleaner for 10 minutes; the aluminum sheet is soaked with 2M H₂SO₄, and placed in the ultrasonic cleaner for 5 minutes; after the aluminum sheet is cleaned with deionized water, the aluminum sheet is placed in 1M NaOH, and stirred thoroughly for 1 minute; after the aluminum sheet is cleaned with deionized water, the aluminum sheet is baked, and the pretreatment process of the aluminum sheet is completed.

As to the acidic electrolyte described in step S102, 0.5M hydrochloric acid (HCl) is preferable in the embodiment, it is preferable that the electrochemical method used is current pulse method, the current pulse method sets constant current pulse by a power supply, the constant current pulse is 0.1 to 1.0 A/cm² and 10 seconds, 0 A/cm² and 15 seconds, the anode is the aluminum sheet, the cathode is the platinum sheet, and the dissolution of the aluminum material is accelerated to form an acidic aluminum salt (AlCl₃) solution.

Only considering the chemical dissolution, the chemical dissolution rate of basic aluminum salt system is high, but it is easy to retain sodium, potassium and other metal ions, which affect the purity of synthetic powder and subsequent electronic-grade applications. In contrast, although the acidic aluminum salt system has no sodium, potassium and other metal ion impurities, the chemical dissolution rate is very poor. Therefore, the present disclosure uses electrochemical dissolution (electrodissolution) to improve the solution rate, adding a small positive bias to the acidic dissolving system, which promotes the oxidation reaction of aluminum to increase the dissolution rate of aluminum.

However, under the condition of electrolyzing aluminum in a state of the constant current for a long time, the problem of electrode surface polarization becomes more and more serious, which will cause the problem of overpotential rise of electrode surface or surface temperature rise. In the electrochemical dissolution reaction is accompanied by an electrolytic reaction of water at the same time, so there will be oxygen accumulation on the surface. Although stirring can be used to increase mechanical disturbances in the solution to take away the gas generated on the surface of the electrode, it is still easy to produce by-products with the increase of reaction time, so the electrochemical dissolution performed by current pulse method is attempted. The advantage of the method is that when the pulse current is 0 or a small reverse current, the polarization of the electrode surface that is caused by the constant current reaction continuing a long time can be carried out depolarization, so that an overpotential produced by the polarization of the electrode surface is reduced. Accordingly, it provides an effective and stable method for an electrochemical process that has a large number of reactions and continues a long time.

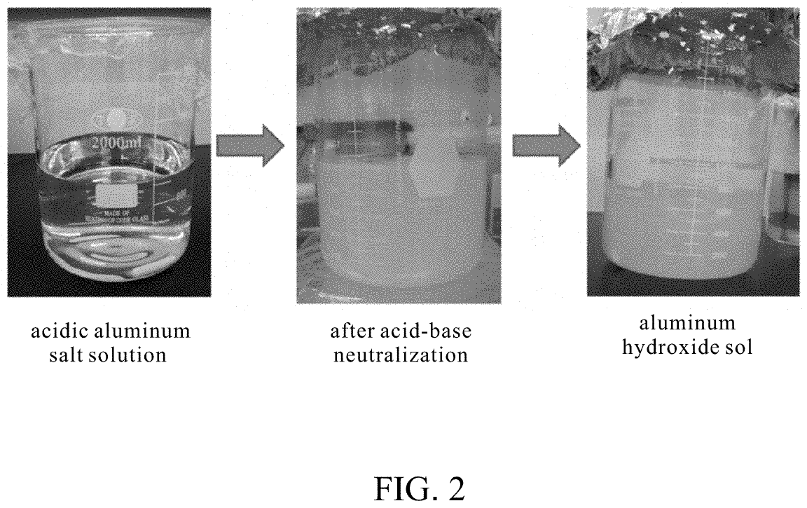

As to the basic solution described in step S103, ammonia water (NH₄OH) is preferable in the embodiment, the basic ammonia water (NH₄OH) is used to perform the acid-base neutralization of the acidic aluminum salt solution, and the pH is neutralized between 6 and 8 to form an aluminum hydroxide (Al(OH)₃) sol. Referring to FIG. 2, FIG. 2 shows photos of the aluminum hydroxide sol after electrochemical dissolving the acidic aluminum salt and the neutralization with the basic solution according to an embodiment of the present disclosure.

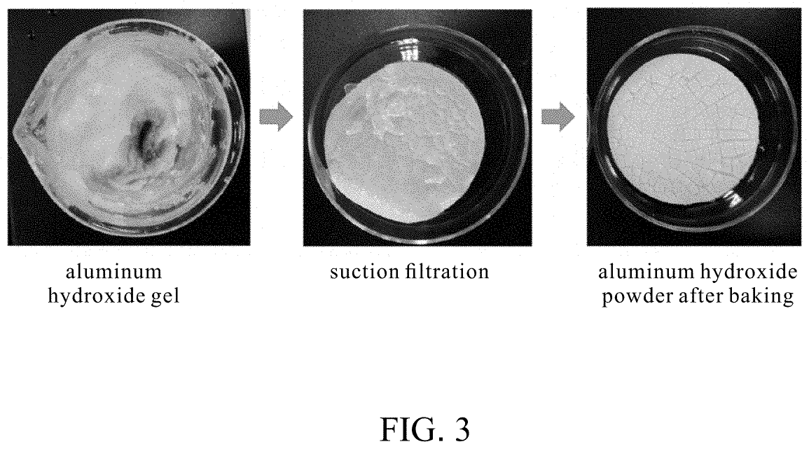

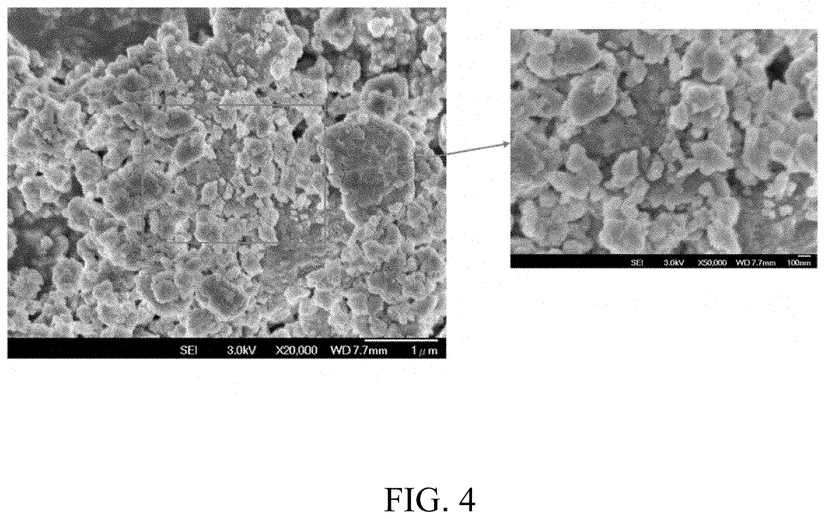

As to the additive described in step S104, sodium chloride (NaCl) or ammonium chloride (NH₄Cl) salt is preferable in this embodiment, the concentration is between 0.01M and 0.5M, and the acid-base value is controlled at pH value between 6 and 8, and then the aluminum hydroxide sol is carried out suction filtration, dried by oven with temperature set 80 to 100° C., or dried at a low temperature by a heating plate with temperature set 80 to 100° C. to obtain nanoscale aluminum hydroxide powder. Referring to FIGS. 3 and 4, they show photos of aluminum hydroxide powder obtained by the aluminum hydroxide sol after suction filtration and drying, and a spectrum of graph of scanning electron microscope of aluminum hydroxide powder according to the embodiment of the present disclosure, it can be seen from the results of electron micrograph that the particle size of aluminum hydroxide powder is about 100 nm, and the particle size of aluminum hydroxide powder without the addition of the additive is about 10 μm, showing the particle size control effect of the additive.

As to the high temperature roasting described in step S105, temperature control is carried out by heating up to 100° C. at a rate of 10° C./min, holding the temperature for 30 minutes, then heating up to a roasting temperature TA at the rate of 20° C./min, holding the temperature for t hour(s), and finally the furnace is cooled to normal temperature, the roasting temperature TA is between 600° C. and 900° C., and the temperature holding time t is 1 to 5 hours. After the aluminum hydroxide powder is carried out the high temperature roasting, micron scale γ-aluminum oxide powder can be obtained.

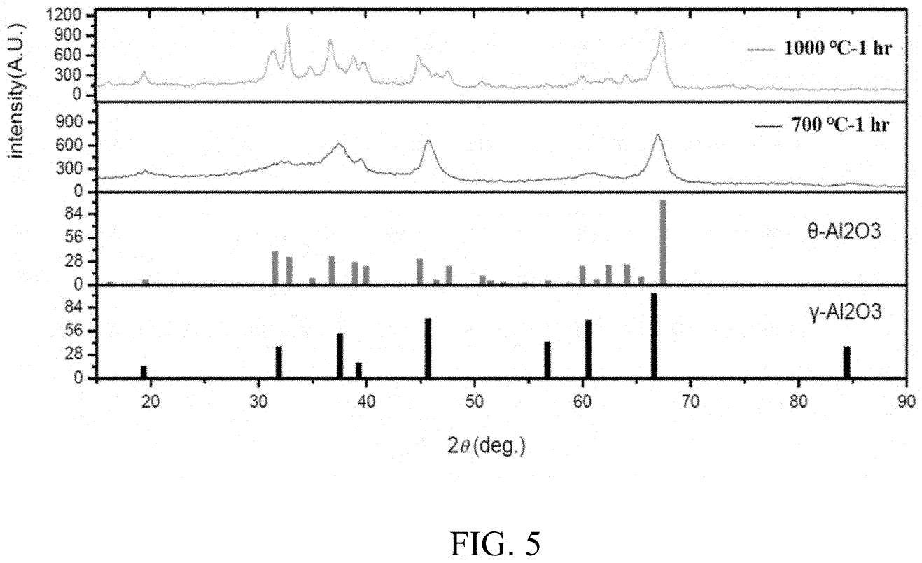

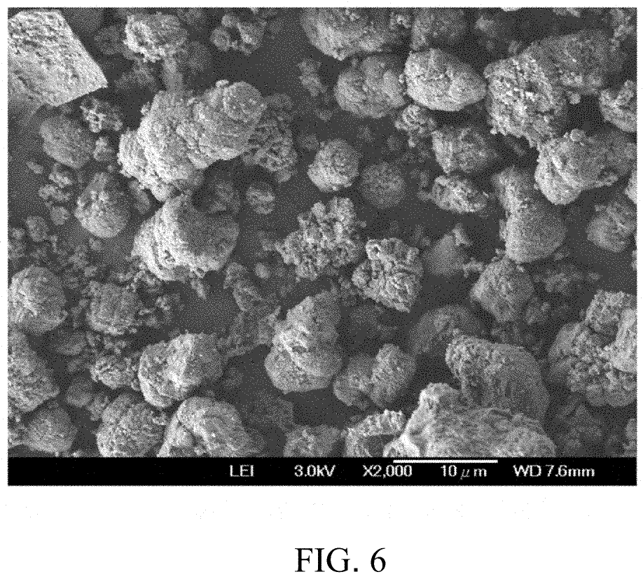

Referring to FIG. 5, FIG. 5 is a spectrum of graph of x-ray diffraction of aluminum oxide powder after high temperature roasting according to the embodiment of the present disclosure, it can be found that aluminum hydroxide can be converted to γ-aluminum oxide under the condition of holding the temperature of 700° C. for 1 hour, but is completely converted to θ-aluminum oxide under the condition of 1000° C. Referring to FIG. 6, FIG. 6 is a spectrum of graph of scanning electron microscope of γ-aluminum hydroxide powder after the high temperature roasting synthesis of 700° C. according to the embodiment of the present disclosure, it can be found from the electron micrograph that the particle size of γ-aluminum hydroxide powder synthesized by the embodiment of the present disclosure is about 5 to 10 μm.

According to the description of the above-mentioned embodiments, a method for producing aluminum oxide powder by electrochemical dissolving aluminum salt of the present disclosure can improve the dissolving rate of aluminum material and increase the output efficiency of aluminum salt, using aluminum metal as the starting raw material, combined with acidic aluminum salt method and electrochemical dissolution method, and going with the current pulse design. The aluminum salt is carried out the acid-base neutralization to produce an aluminum hydroxide sol, and an additive is added to the sol to control the particle size of the aluminum hydroxide sol, producing nanoscale aluminum hydroxide powder, reducing the roasting temperature of subsequent synthetic aluminum oxide powder, and finally obtaining high-quality micron scale γ-phase aluminum oxide powder after roasting at 600° C. to 900° C. The purpose of the disclosure is to develop γ-phase aluminum oxide powder with characteristics of high purity and low cost, which can be used as a starting material for carbothermic reduction process and can be used for the synthesis of high-purity aluminum nitride powder.

The above embodiments of the disclosure made only by way of example to describe the feature and effect of the disclosure, and it should not be considered as the scope of substantial technical content is limited thereby. Various possible modifications and alternations of the embodiments could be carried out by the those of ordinary skill in the art without departing from the spirit and scope of the disclosure. Therefore, the scope of the disclosure is based on the appended claims.

What is claimed is:

1. A method for producing aluminum oxide powder by electrochemical dissolving aluminum salt, steps comprising:
(A) providing an electrochemical device with an aluminum material as an anode and an acidic solution as an electrolyte;
(B) accelerating the dissolution of the aluminum material by current pulse method to form an acidic aluminum salt solution;
(C) neutralizing the acidic aluminum salt solution with a basic solution to form an aluminum hydroxide sol, a particle size of the aluminum hydroxide sol is in the range of 1 to 10 μm;
(D) adding an additive in the aluminum hydroxide sol to control the particle size of the aluminum hydroxide sol to the nanoscale, filtering the aluminum hydroxide sol and drying to form aluminum hydroxide powder, a particle size of the aluminum hydroxide powder is in the range of 30 to 300 nm;
(E) roasting the aluminum hydroxide powder at a high temperature to form micron scale γ-aluminum oxide powder.

2. The method for producing aluminum oxide powder by electrochemical dissolving aluminum salt according to claim 1, wherein the aluminum material of the step (A) is an aluminum scrap or aluminum sheet with a purity of 3N grade or above;
the electrochemical device is an electrochemical dual electrode system with one of platinum, gold and graphite as a cathode material.

3. The method for producing aluminum oxide powder by electrochemical dissolving aluminum salt according to claim 1, wherein the acidic electrolyte of the step (A) is selected from the group consisting of hydrochloric acid (HCl), sulfuric acid (H₂SO₄) and nitric acid (HNO₃), a concentration of the acidic electrolyte is between 0.5M and 3M.

4. The method for producing aluminum oxide powder by electrochemical dissolving aluminum salt according to claim 1, wherein the current pulse method of the step (B) sets constant current pulse by a power supply, the constant current pulse is 0.1 to 1.0 A/cm² and 10 seconds, 0 A/cm² and 15 seconds for a cycle, number of pulse current cycles is more than 20 times, the total electrolysis time is more than 500 seconds.

5. The method for producing aluminum oxide powder by electrochemical dissolving aluminum salt according to claim 1, wherein the basic solution of the step (C) is selected from the group consisting of sodium hydroxide (NaOH), ammonia water (NH₄OH) and potassium hydroxide (KOH), the basic solution is used to perform the acid-base neutralization of the acidic aluminum salt solution, and the pH is neutralized between 6 and 8 to form an aluminum hydroxide (Al(OH)₃) sol.

6. The method for producing aluminum oxide powder by electrochemical dissolving aluminum salt according to claim 1, wherein the additive of the step (D) is selected from the group consisting of sodium chloride (NaCl), ammonium chloride (NH₄Cl), 3-mercapto-1-propanesulfonic acid sodium salt (MPS) and 4-dodecylbenzenesulfonic acid (DBSA).

7. The method for producing aluminum oxide powder by electrochemical dissolving aluminum salt according to claim 6, wherein a concentration of the additive is between 0.01M and 0.5M, and the acid-base value is controlled at pH value between 6 and 8.

8. The method for producing aluminum oxide powder by electrochemical dissolving aluminum salt according to claim 1, wherein the filtering and drying process of the step (D) is allowing the aluminum hydroxide sol to carry out suction filtration, and then is dried at a low temperature by oven or a heating plate with temperature set 80 to 100° C. to form nanoscale aluminum hydroxide powder.

9. The method for producing aluminum oxide powder by electrochemical dissolving aluminum salt according to claim 1, wherein a temperature of the high temperature roasting of the step (E) is between 600° C. and 1000° C., and a temperature holding time is 1 to 5 hours.

10. The method for producing aluminum oxide powder by electrochemical dissolving aluminum salt according to claim 9, wherein the temperature of the high temperature roasting of the step (E) is between 600° C. and 1000° C., and the temperature holding time is 1 to 5 hours to form the micron scale γ-aluminum oxide powder.
